(19) United States
(12) Patent Application Publication
(10) Pub. No.: US 2009/0155496 A1
(43) Pub. Date: Jun. 18, 2009

(54) FILAMENT OR FIBRE

(75) Inventors: Johannes T.A. Wilderbeek, Veghel (NL); Michel P.B. Van Bruggen, Helmond (NL); Jan M. Krans, Den Bosch (NL); Jacob M.J. Den Toonder, Helmond (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,389

(22) PCT Filed: May 19, 2005
(86) PCT No.: PCT/IB05/51630

§ 371 Date: Nov. 20, 2006

(30) Foreign Application Priority Data
May 21, 2004 (GB) 0411349.4

(51) Int. Cl. C09K 19/38; B05D 3/02

(52) U.S. Cl. 428/1.33; 427/393.5

(57) ABSTRACT

A filament or fibre (2) comprising: a first conductive layer (4); an electro-optically active layer (6); a second conductive layer (8); wherein the filament or fibre has an off-state and an on-state, the electro-optically active layer comprising a combination of an electro-optically active substance and a polymer.

This invention relates a fibre or filament, especially one that is suitable for inclusion in a fabric or garment with the aim of producing optically detectable effects therein.

Various methods of producing colour changing, or light emitting fibres are known.

One known method is based on the use of an electrolumiphore material which emits light under the influence of an electric field. Such a method is described in UK patent application No. GB 2273606 and International patent application No. WO 97/15939. The electric field used in such methods is created by integrating at least two electrodes in a fibre.

Other known methods also make use of specific thermochromic materials, i.e., materials that change colour under the influence of a change in temperature. Such a method is disclosed in European patent publication No. EP 0 410 415.

Other known methods have used liquid crystalline material as electro-optically active material for forming a filament or fibre adapted to have optically detectable effects.

A problem associated with liquid crystal based active layers is the inherit lack of sufficient mechanical stability associated with liquid crystalline materials. As the liquid crystal layer constitutes primarily low molecular weight components, the overall material behaviour is that of a liquid or liquid-like layer. This greatly complicates the construction and processing of a fibre or filament. When it is required to apply an overlying second electrode, the process is extremely cumbersome and problematic.

In addition, the achievable contrast of pure liquid crystal based layers is often insufficient, and additional functional layers are required, such as polarizers or brightness enhancement layers.

It is an object of the present invention to provide a filament or fibre having at least one optical property that is controllably alterable, and in which the filament or fibre has improved mechanical stability.

According to a first aspect of the present invention there is provided a filament or fibre comprising:
a first conductive layer;
an electro-optically active layer;
a second conductive layer;
wherein the filament or fibre has an off-state and an on-state, the electro-optically active layer comprising a combination of an electro-optically active substance and a polymer.

The electro-optically active layer may comprise flexible polymers, side-chain liquid crystal polymers, main-chain liquid crystalline polymers, isotropic or anisotropic network type structures, of covalent or non-covalent, supramolecular nature, or dispersed polymer particles.

The presence of a polymer in the electro-optically active layer can produce a stabilising effect on the mechanical properties of the filament or fibre which increases the manufacturing options and simplifies processing.

Advantageously, the electro-optically active substance comprises a liquid crystalline material.

Liquid crystalline materials of the type generally used for electro-optical applications have a low molecular weight. By combining such a material with a high molecular weight polymer, the properties of the electro-optically active layer will become less liquid-like and more solid-like.

The properties of the electro-optically active layer may be tailored to produce a filament or fibre with appropriate properties, by using appropriate proportions of polymer and liquid crystalline material.

In other words, the polymer forming part of the electro-optically active layer will change the mechanical material behaviour of the liquid crystalline material from liquid-like (for pure low molecular weight liquid crystal materials) to more solid-like. This results in more mechanically stable behaviour, thus making the use of liquid crystal based effects more realistic for, for use in, for example, textile electronics.

A further advantage of using a combination of an electro-optically active substance and a polymer to form the electro-optically active layer in the filament or fibre is that reduced driving voltages, improved contrast, enhanced viewing angles (reduced off-axes haze) (see for instance Yang, D.-K., Chien, L.-C., Doane, J. W., Appl. Phys. Lett., 60, p. 3102, 1992), are achievable when compared with filaments or fibres in which the electro-optically active layer comprises solely liquid crystalline material.

These improvements are known from the electro-optical characterization of conventional liquid crystal display applications. Switching voltages of twisted nematic (TN) devices of the order of 2-3 V can for instance be lowered to approximately 1 V when stabilized with 2% polymer. See for instance Bos, P. J., Rahman, J., Doane, J. W., SID Dig. Tech. Pap., 24, p. 877, 1993. Similar findings are observed for super twisted nematic (STN) devices.

In addition, it is possible to reduce or eliminate defects such as stripe deformations in 270° super twisted nematic liquid crystals. See for instance Bos, P. J., Fredley, D., Li, J., Rahman, J. in “Liquid crystals in complex geometries. Formed by polymer and porous networks”, Crawford, G. P., Zumer, S. (Eds.), Chapter 13, Taylor & Francis, London, 1996.

The liquid crystalline material may comprise any suitable liquid crystal or mixture of liquid crystals such as liquid crystals used for TN or STN configurations.

The combination of an electro-optically active substance, such as a liquid crystalline substance, and a polymer to form the electro-optically active layer in the filament or fibre, can consist of a homogeneous or inhomogeneous mixture, depending on the ratio of the constituents and the manufacturing conditions, of which the polymerisation conditions can be an important aspect.

Advantageously, the electro-optically active layer comprises a polymer content of between 0.5 to 40%.

Preferably, the electro-optically active layer comprises a polymer stabilized ferro-electric or anti-ferro-electric liquid crystalline material. Such a layer may be used to create extremely fast switching filaments or fibres with typical switching rates in the range from 200 ms to 20 ms.

In another preferred embodiment of the present invention the electro-optically active material comprises a polymer stabilized chiral, nematic or cholesteric fibre. Fibres incorporating such an electro-optically active layer may also include colours that can be accurately tuned. Chiral nematic or cholesteric liquid crystals show a polarization-selective reflection provided the wavelength of the circularly polarized incoming light fulfils the reflection condition:

where I is the wavelength of the reflected light, is the average refractive index of the liquid crystal, and p is the pitch length of the helix of the liquid crystal director. One handedness of the incoming circularly polarized light is absorbed and reflected, whereas the other handedness is transmitted, provided a monolithically aligned liquid crystal is used (e.g. having a Grandjean or fingerprint texture). The exact color can be tuned by the choice of materials, e.g. the choice of liquid crystal, and for instance the polymerisation conditions, determining the effective pitch of the chiral nematic phase.

Conveniently the ratio of polymer to liquid crystal in the electro-optically active layer may be any suitable ratio, but preferably is in the region of 30-99.8%, more preferably 50-80%. Such polymer systems are known as polymer dispersed liquid crystal (PDLC) systems.

When the polymer system is a PDLC system, the polymer preferably comprises a substantially continuous isotropic polymer phase, and the liquid crystalline material comprises a dispersed liquid crystalline phase.

Advantageously, the liquid crystalline phase comprises droplets or domains, having an average diameter in the range 0.3-3 mm, preferably in the range 1-2 mm, containing liquid crystalline material. Usually, a modal dispersion in/of the diameter of the droplets or domains is observed.

Conveniently, the liquid crystalline phase is randomly aligned, and of nematic nature, although in principle other liquid crystalline phases, such as chiral nematic, smectic, or discotic phases can be used too. In the off-state of the filament or fibre, there is a mismatch between the isotropic refractive index of the continuous polymeric phase, and that of the randomly aligned dispersed liquid crystalline phase. Because of this, and the micron sized domain size of the liquid crystalline phase, light scattering will occur, resulting in a white layer.

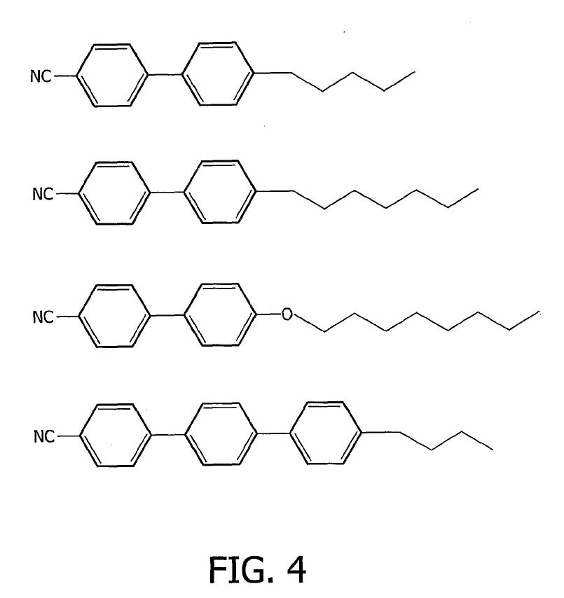

Upon application of a voltage inducing the on-state, the director of the dispersed nematic liquid crystalline droplets will orient parallel to the electric field, provided the liquid crystalline phase has a positive dielectric anisotropy. If the materials are chosen such that the refractive index of the polymer phase matches the ordinary refractive index of the liquid crystalline dispersed phase, no effective refractive index mismatch is experienced, and the layer will appear transparent. A particularly well-suited material combination is for instance, the NOA 65/E7 system, that can be obtained from Norland (Cranbury, N.J., USA) and Merck (Darmstadt, Germany), respectively. The liquid crystal E7 (see FIG. 4) is actually a eutectic mixture consisting of 50.6% 4′-pentylcyanobiphenyl, 25.2% 4′-heptylcyanobiphenyl, 17.8% 4′-octyloxycyanobiphenyl, and 6.4% 4′-pentylcyanoterphenyl (see Wilderbeek et al., Advanced Materials, 15(12), p. 985-988, 2003).

Examples of further materials and useful combinations are for instance extensively described in Drzaic, P. S., “Liquid crystal dispersions”, World Scientific, Singapore, 1995. Due to the aligned director in the on-state, an off-axis refractive mismatch of the refractive indices will exist, resulting in an angle-dependent hazy appearance.

Alternatively, the polymer materials and liquid crystalline materials can be chosen such that their respective refractive indices, i.e. the isotropic polymer refractive index and the ordinary refractive index of the dispersed liquid crystalline phase, match in the on-state, when an electric field is present. In this case, the on-state is the transparent state, and the off-state is the opaque state. Other combinations, such as matching of the isotropic polymer refractive index with the extraordinary refractive index of the dispersed liquid crystalline phase, or using liquid crystalline materials with negative dielectric anisotropy, are also possible.

Alternatively, the electro-optically active layer comprises an anisotropic gel comprising a polymer having a polymer backbone to which mesogenic cores are attached, and a liquid crystalline substance.

Preferably, the fibre or filament has a substantially circular cross section, the first conductive layer comprising an inner conductive core extending axially along the filament or fibre, and the second conductive layer comprising an outer electrode, the electro-optically active layer being positioned between the inner core and the outer electrode.

Advantageously, the outer electrode is at least partially transparent.

Alternatively, the fibre or filament has a substantially square or rectangular cross section, the first conductive layer comprising a bottom electrode, the second conductive layer comprising a top electrode, and the electro-optically actively layer being positioned between the bottom and the top electrode layers.

According to a second aspect of the present invention there is provided a method for forming a filament or fibre comprising:

forming a first conductive layer;

applying an electro-optically active layer either directly, or indirectly, to the first conductive layer;

applying a second conductive layer, either directly, or indirectly, to the electro-optically active layer, wherein the electro-optically active layer is formed by:
(i) forming the electro-optically active layer from a homogeneous system of cross linkable monomers and a non-reactive mesogen, prior to applying the electro-optically active layer to the first conductor;
(ii) inducing a phase change in the homogeneous system.

The phase change in the homogeneous system may take place either before or after application of the second conductive layer.

Preferably the step of inducing a phase change comprises illuminating or heating the filament or fibre.

According to a third aspect of the present invention there is provided a method for forming a filament or fibre comprising:

forming a first conductive layer;

applying an electro-optically active layer either directly, or indirectly, to the first conductive layer;

applying a second conductive layer, either directly, or indirectly, to the electro-optically active layer, wherein the electro-optically active layer is formed by:
(i) forming the electro-optically active layer from a homogeneous system of at least a polymer and a non-reactive mesogen, in combination with a common solvent, prior to applying the electro-optically active layer to the first conductor;
(ii) removing of the solvent.

The solvent may be removed before application of the second conductive layer. This results in a heterogeneous system.

Alternatively, the solvent may be removed after application of the second conductive layer. This results in a homogeneous system.

Optionally, the method comprises the additional step of heating the homogeneous or heterogeneous system.

The invention will now be further described by way of example only with reference to the accompanying drawings in which:

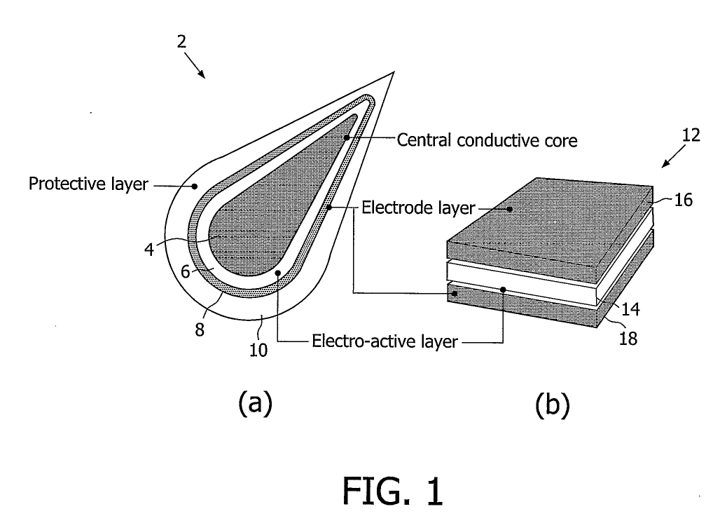

FIGS. 1a and 1b are schematic representations of a fibre according to a first embodiment of the invention.

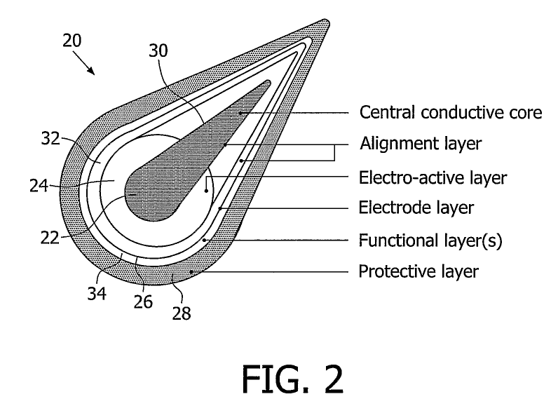

FIG. 2 is a schematic representation of a fibre according to a second embodiment of the present invention;

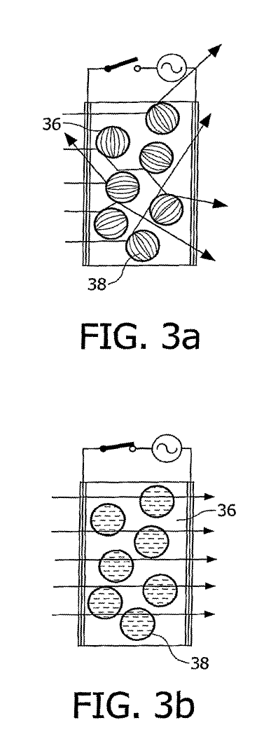

FIGS. 3a and 3b are schematic representations of a polymer dispersed liquid crystal optical element suitable for forming the electro-optically active layer forming a fibre according to the present invention;

FIG. 4 shows the chemical composition of a non-reactive liquid crystalline mixture E7;

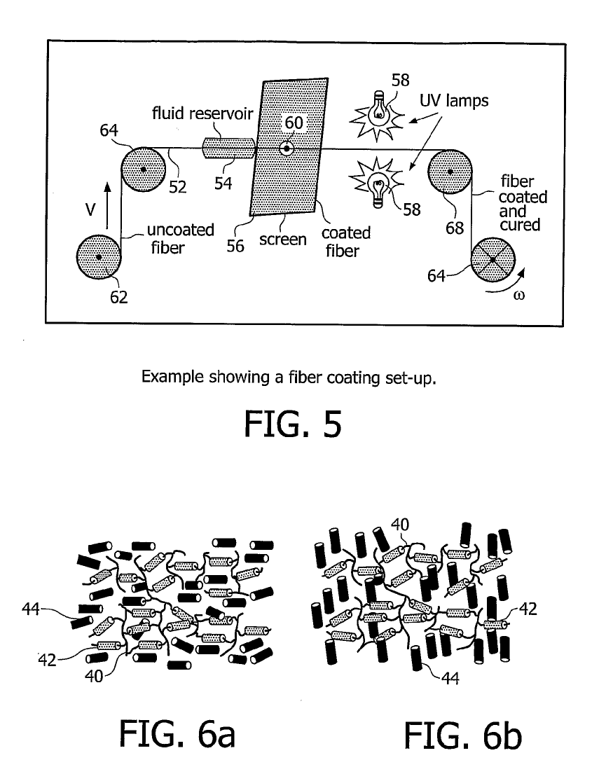

FIG. 5 is a schematic representation of a set up for a continuous manufacturing process for manufacturing a fibre or filament according to the present invention;

FIGS. 6a and 6b are schematic representations of an isotropic gel suitable for forming the electro-optically active layer forming a filament or fibre according to the present invention;

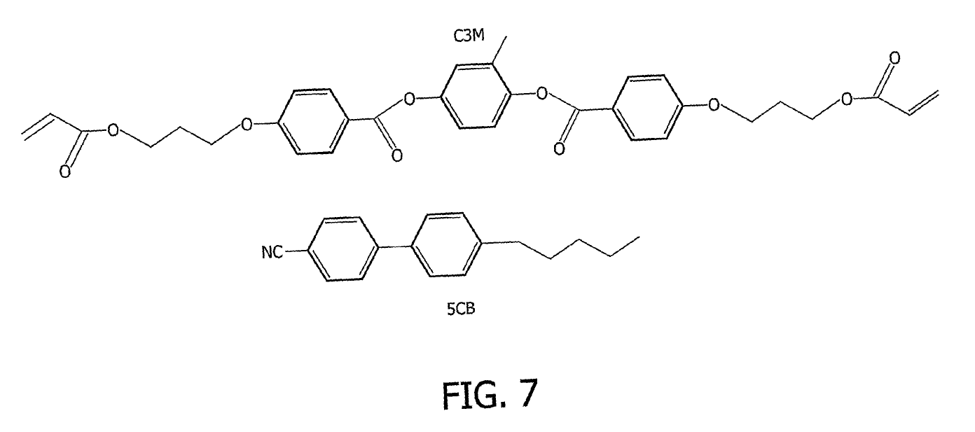

FIG. 7 shows the chemical composition of C3M and 5CB polymers suitable for use in the present invention.

Referring to FIGS. 1a and 1b, fibres, according to a first embodiment of the present invention are shown schematically.

FIG. 1a shows a fibre 2 comprising a central conductive core 4 extending axially along the fibre. The core is surrounded by an electro-optically active layer 6 which in turn is surrounded by an outer electrode 8. The fibre 2 further comprises a protective layer 10.

It is to be understood that a conductive core according to the present invention is designated generally by the reference numeral 4. Although the conductive core may directly consist of a conductive metal wire, the conductive core 4 may also comprise an elongate core, preferably formed from an electrically insulating material, the core having a core axis, and covered by an electrically conductive material. The electrically conductive material may be fabricated in several ways, by using thin layer deposition techniques, lithographic methods, X-ray lithography, particle beams and other non-lithographic techniques.

The electrode material can be either inorganic or organic and includes, but is not limited to, indium tin oxide, gold, silver, copper, platinum, and their derivatives, and conductive or semi-conductive oligomers or polymers, e.g. polyaniline and thiophene derivatives such a poly(3,4-ethylenedioxythiophene): PEDT or PEDOT.

Optionally, these oligomers or polymers may contain additives to optimise the electrical and thermal conductivity, and enhance the lifetime.

In preferred embodiments, the core is substantially cylindrical in shape and may be formed from a non-conductive flexible polymer fibre. Examples of suitable polymer fibres include, but are not limited to, polyesters, polyamides, polyacrylics, polypropylenes, vinyl-based polymers, wool, silk, flax, hemp, linen, jute, rayon-based fibres, cellulose acetate-based fibres and cotton.

An advantage of using polymer fibres is that they are readily available and have mechanical properties which can be adapted to suit the particular fibre requirement e.g. in terms of strength and flexibility. This is to be contrasted with conductive metal wires which have only a limited range of mechanical properties.

It is furthermore to be understood that the conductive core as described above, may optionally also include one or more additional coatings, overlaying the electrically conductive material. The primary function of this coating is preferably to protect the electrodes, since these are by nature very fine and delicate. However, the coating may also perform a secondary function which includes, but is not limited to, an adhesion layer, a barrier layer, a sealing or covering layer, a UV shielding layer, a polarizing layer, a brightness enhancing or perception improvement layer, a colouration layer, an additional conductive or semi-conductive electrode layer, a channelling layer, a dielectric layer or any combinations thereof.

The fibre shown in FIG. 1b has a ribbon-like or flat fibre layout. This fibre 12 comprises an electro-optically active layer 14 surrounded by first and second electrode layers 16, 18.

These basic configurations may have further layers added as appropriate, as shown in FIG. 2, and the fibre 2, 12 may not always have a protective layer 10.

FIG. 2 illustrates a fibre 20 comprising a central conductive core 22, an electro-optically active layer 24, an outer electrode layer 26 and a protective layer 28. The fibre 20 comprises a first alignment layer 30 positioned between the central core 22 and the electro-optically active layer 24, and a second alignment layer 32 positioned between the electro-optically active layer 24 and the outer electrode 26.

Again, it is to be understood that a conductive core according to the present invention may directly consist of a conductive metal wire, but the conductive core 22 may also comprise a non-conductive core, preferably formed from an electrically insulating material, that is covered by an electrically conductive material.

The fibre 20 further comprises a functional layer 34 which will be described in more detail herein below.

It is to be understood that the alignment layers and the functional layers are not essential to all embodiments of the present invention. The nature of the electro-optically active layer will determine the structure of the fibre.

For instance, alignment layers are required in those systems where the orientation in a preferred direction is essential to the functioning of the electro-optical layer. For example, it may be preferred to induce a well-defined twist of the liquid crystalline director in a TN or STN device by aligning the liquid crystals at the boundaries of the electro-optically active layer. As these switching principles are based on the modulation of the polarization of the incident light, usually at least one polarization layer is required to make the effect visible. Furthermore, additional requirements may hold for these specific systems, such as the control over the retardation, dDn, where d is the thickness of the electro-optically active layer and Dn is the birefringence of the liquid crystalline phase (see for instance Gooch, C. H., Tarry, H. A., Electronics Letters, 10, p. 2, 1974, and Gooch, C. H., Tarry, H. A., J. Phys. D: Appl. Phys., 8, p. 1575, 1975.

In addition, further features may be present in the fibre, for example, thin metal wires may be wound around the outer electrode, which wires act as an electrical shunt. Spacers may be included to define the thickness of electro-optically active layer. The spacer means are preferably formed from a non-conductive material, such as glass or polystyrene, and may be in the form of, for example, elongate wires or substantially spherical beads of specific size, or thin continuous filaments wound around the core electrode. The wound filaments are thus situated between the core electrode and the outer electrode and define the spacing between them.

The electro-optically active layer forming part of the fibre or filament of the present invention, is a combination of a polymer and the electro-optically active substance such as liquid crystalline material.

A fibre of the type shown in FIG. 2 is formed by coating an electrically conductive fibre core using conventional methods such as dip coating, spray coating, vapour deposition, ink-jet printing, micro-contact printing or sputtering, with a liquid crystal alignment layer such as a polyimide derivative, or a photoalignment layer.

Examples of alignment layers are extensively described in the literature, see for instance Cognard, J., Mol. Cryst. Liq. Cryst. Suppl. Ser., 1, p. 1-77, 1982. Non-limitative examples are polyimide layers, photoorientable layers, such as coumarin-based or cinnamate-based polymers or layers consisting of surfactants. Also, mechanical interaction with the fibre core may induce the preferred alignment of the liquid crystals.

The use of a polyimide alignment layer can be advantageous as the rubbing conventionally required for inducing the desired alignment can be directly accomplished via the manufacturing method. However, mechanical rubbing introduces defects and is a source of electrostatic discharge and dust.

Preferably, photoalignment layers are used, as the alignment can be induced by illumination which is a non-contact method (see for instance Schadt, M. et al., Nature, 381, p. 212, 1996, and Wilderbeek et al., Advanced Materials, 15(12), p. 985, 2003).

The liquid crystal alignment layer is conventionally finalized using heat curing or UV-irradiation and effects a pre-tilt angle of 3 to 4°. This pre-tilt is required to lower the threshold voltage for switching, and to control the rotation direction of the liquid crystals, thus reducing for instance the formation of disclinations.

The fibre is subsequently coated by applying an electro-optically active layer either directly, or indirectly, to the first conductive layer.

The electro-optically active layer can be formed using several procedures:
(i) directly, by applying an inhomogeneous polymer/LC system directly to the fibre. Usually, the rheology of such a system is paste-like, allowing for the practical deposition on the fibre.
(ii) indirectly, by applying a homogeneous polymer/LC system directly to the fibre, using a suitable common solvent to the polymer and mesogen. Upon removal of the solvent, e.g. by evaporation or curing, the final morphology is established as a coating on the fibre.
(iii) Indirectly, by in-situ generation, using an initially homogeneous mixture of crosslinkable monomers and a non-reactive mesogen. After application of the mixture on the fibre, phase separation is induced either
a. Thermally
b. By (photo-)chemical means.

Optionally, a second alignment layer may be applied to the electro-optically active layer. A second electrode is then applied to the second alignment layer, or directly to the electro-optically active layer.

The second electrode may be applied to the electro-optically active layer before, or after the layer has been formed.

Usually, the fibre, or stack is covered by a protective cover layer to protect the electro-optic substance 6 and to provide additional stability and support in the fibre 2 or 12. Preferably the protective cover is formed from a non-conductive material and is at least partially transparent to light. Conveniently, the protective cover is formed from a flexible polymer.

Various polymers/liquid crystal composites may be used. One such composite is a polymer dispersed liquid crystal system (PDLC) containing a relatively high, for example, 50 to 80% polymer content. Such a system comprises a continuous isotropic polymer phase and a dispersed low molecular weight micron sized liquid crystalline phase.

Referring to FIGS. 3a and 3b, such a system is shown initially in the off-state in FIG. 3a and then in the on-state in FIG. 3b. The system comprises an isotropic polymer phase 36 and a dispersed low molecular weight micron sized liquid crystalline phase 38.

In the off-state shown in FIG. 3a, there is a mismatch between the isotropic refractive index of the continuous polymeric phase, and that of the randomly aligned dispersed liquid crystal phase. Because of this, and the micron sized domain size, light scattering will occur, resulting a white layer.

Preferably, the liquid crystalline phase is a nematic phase, although in principle other liquid crystalline phases, such as chiral nematic, smectic, or discotic phases can be used too.

Upon application of a voltage in the on-state as shown in FIG. 3b, the director of the dispersed nematic liquid crystalline droplets 38 will orient parallel to the electric field, provided the nematic liquid crystal has a positive dielectric anisotropy.

If the materials are chosen such that the refractive index of the polymer 36 matches the ordinary refractive index of the dispersed liquid crystalline phase 38, no effective refractive index mismatch is experienced and the layer will appear transparent.

A particular well-suited material combination illustrated in FIG. 4 is for instance the NOA 65/E7 system, that can be obtained from Norland (Cranbury, N.J., USA) and Merck (Darmstadt, Germany), respectively. The liquid crystal E7 is actually a eutectic mixture consisting of 50.6% 4′-pentylcyanobiphenyl, 25.2% 4′-heptylcyanobiphenyl, 17.8% 4′-octyloxycyanobiphenyl, and 6.4% 4′-pentylcyanoterphenyl (see Wilderbeek et al., Advanced Materials, 15(12), p. 985-988, 2003). Another example consists of the epoxy EPON 828 (Shell Chemical Co.), the curing agent Capcure 3800 (Miller-Stephenson Chemical Co.), and the liquid crystal E7. Yet another example consists of polymethylmethacrylate (PMMA) and the liquid crystal E7, using the common solvent chloroform. Examples of further materials and useful combinations are for instance extensively described in Drzaic, P. S., “Liquid crystal dispersions”, World Scientific, Singapore, 1995

Due to the aligned director in the on-state, shown in FIG. 3b, an off axis refractive mismatch of the refractive indices will exist, resulting in an angle dependent hazy appearance. This type of polymer/liquid crystal composite system may be generated in situ, as described above, by inducing a phase separation from an initially homogeneous system of crosslinkable monomers and a non-reactive mesogen. The phase separation is either induced thermally, by evaporation of a co-solvent, or by chemical or photochemical means.

During the course of these processes, phase separation into polymer-rich and polymer-poor regions will occur, and the final morphology can be accurately tuned, depending on the proper process conditions.

An advantage of such a system is the resulting mechanical stability. The overall characteristics of the electro-optically active layer are that of a solid-like material.

In addition, polarizers and alignment layers are not required as the switching principle of a PDLC is based on scattering, rather than modulation of the polarization of the incident light. Thus, the exact alignment of the liquid crystals at the boundaries of the electro-optically active layer is not required. In fact, in the off-state, the mesogenic molecules adopt a random director profile that varies from one droplet or domain to the other droplet or domain.

Furthermore, the concept is suited for production in a continuous process. The phase separation kinetics can be very fast, and phase separation can be achieved within minutes to several seconds, allowing for reel-to-reel fabrication.

FIG. 5 shows a schematic set-up for a continuous manufacturing process for a fibre or filament according to the present invention. A fibre 52 is drawn through a fluid containing reservoir 54 from reel 62 to reel 64, via rollers 66, 68. The fibre is subsequently coated with the mixture. Formation of the desired morphology can be realized via the methods described herein. Optionally, the morphology may be established using the illumination sources 58 situated after the fluid reservoir.

Optionally, additional reservoirs (not shown) may be present before or after the reservoir 54, for instance to apply different coatings, such as a second electrode, cover layer, alignment layers, adhesion promotion layers, wetting layers, polarizers, brightness enhancement layers, before the fibre is wound up again.

A screen may 56 be used to shield the material present in the fluid reservoir 54 from the light coming from the one or more illumination sources 58 present, such as UV light sources, in order to prevent premature induced chemical or physical changes, such as phase separation and/or polymerisation and/or precipitation and/or degradation, of the material present in the reservoir. A small opening 60 in the screen enables the transport of the fibre from reel 62 to reel 64. Although the screen 56 shown in FIG. 5 has a flat and rectangular layout, the actual shape may differ as long as its shape fulfils the role of shielding the contents of the reservoir 54 from the light coming from the lighting sources 58. For example, a small diaphragm may be used directly at the edge of the fluid reservoir.

The illumination sources 58 can be of various types, but preferably emit or radiate light with a wavelength in the visible to UV region. UV-light sources are particularly appropriate, and for instance medium or high pressure mercury light sources may be used. Optionally, the heat that is produced by these type of lamps can be blocked by placing an infrared screen (not shown), that is transparent to the wavelength required to induce the desired phase change of the electro-optical layer, in between the light source and the fibre 52.

The fibre 52 is transported from its origin, preferably from reel 62 to its destination, or reel 64 with a velocity v (m s−1). The velocity of the fibre is determined by the angular velocity w (rpm or rad s−1) of the reels, as imposed by for instance an electrical motor (not shown).

Preferably, the entire set-up or parts of the set-up can be placed in an enclosure (not shown) that enables control over the environment with respect to the gas conditions. For instance, it may be advantageous to process and/or illuminate the fibre and/or electro-optical layer in an inert atmosphere, such as nitrogen, helium or argon or mixtures thereof, or to process and/or illuminate the fibre and/or electro-optical layer in a pressurized environment different from atmospheric condition (e.g. vacuum, reduced pressure, high pressure).

Good voltage transmission characteristics can be obtained ranging from approximately 1V per micron to 0.5V per micron, across the electro-optically active layer.

The electro-optically active layer described above is suited to produce reflective fibres, as the degree of front and back scattering can be accurately tuned by the processing methods as described herein, and as for instance described by Cornelissen, H. J. et al., Proceedings of the 17th International Display Research Conference, Toronto (Canada), p. 144, 1997.

Optionally, dyes can be added to the polymer/liquid crystal composite in order to produce colour changes in the fibre.

### EXAMPLE 1

A flexible polyester foil (polyethyleneterephtalate) coated with a thin conductive layer of poly(3,4-ethylenedioxythiophene) was covered with a reactive mixture consisting of 60% w/w of multifunctional reactive monomers (NOA65, Norland, Cranbury, N.J., USA) and 40% w/w of a eutectic liquid crystalline mixture (E7, Merck, a mixture consisting of cyanobiphenyls and one cyanoterphenyl, as specified herein). The layer thickness was tuned accurately by using spacers with well-defined thickness by spincoating. Upon irradiation with UV-light, the polymer dispersed liquid crystal is formed. A second electrode, e.g., a second polyester foil with conductive coating, can be applied before or after irradiation. The resulting flexible foil or ribbon-like fibre can be switched between a scattering state and a transparent state with a moderate voltage (10-40V).

### EXAMPLE 2

A conductive core fibre (copper, fibre diameter 120 μm) was coated by passing the fibre horizontally through a reservoir containing a mixture of 60% w/w reactive multifunctional monomers (NOA65, Norland, Cranbury, N.J., USA) and 40% w/w of a eutectic liquid crystalline mixture (E7 Merck, a mixture consisting of cyanobiphenyls and one cyanoterphenyl, as specified herein). The reservoir was 4.0 mm in diameter and 10.0 mm in length. The relative intended thickness of the coating or the ratio of the coating and the conductive fibre radius (e/b) was controlled by the following parameters:
The speed v at which the conductive fibre travels through the reservoir (which is in turn adjusted by the power supplied to the motor)
The capillary number Ca:

(where h is the viscosity, and g is the surface tension of the uncured material).

For an uncured coating of 10 μm thickness with a viscosity of 0.5 Pa.s and a surface tension of 0.037 N/m, the speed was 3.0 mm/s. Curing occurred with medium pressure mercury lamps, situated directly after the fluid reservoir.

A polymer/liquid crystalline material composite may also be formed using anisotropic monomers rather than isotropic monomers.

Such systems may be produced by photopolymerisation of small amounts of anisotropic monomers in the presence of a non-reactive low molecular weight liquid crystalline solvent. Typically, acrylates, methacrylates, or epoxides are used for the anisotropic monomers, and a well-described example consists of the reactive mesogenic acrylate monomer benzoic acid, 4-[3-[(oxo-2-propenyl)oxy]propoxy]-,2-methyl-1,4-phenylene ester (C3M) and the non-reactive liquid crystal 5CB (4′-pentyl, [1,1-biphenyl]-4-carbonitrile), as shown in FIG. 7. See for instance Hikmet, R. A. M. in “Liquid crystals in complex geometries. Formed by polymer and porous networks”, Crawford, G. P., Zumer, S. (Eds.), Chapter 3, Taylor & Francis, London, 1996, and Wilderbeek et al., Jpn. J. Appl. Phys., Part 1, 41 (4A), p. 2128, 2002.

Photopolymerisation of initially homogeneous mixtures of an anisotropic monomers and low molecular weight liquid crystalline solvents produces phase separation of the liquid crystalline polymeric structure into polymer-rich and polymer-poor phases. Depending on the molecular structure of the monomer used, the formed polymers are either side-chain or chemically crosslinked structures, both consisting of a polymer backbone to which mesogenic cores are attached. Such polymers are known as anisotropic gels or plasticized liquid crystalline networks and are schematically illustrated in FIGS. 6a and 6b described herein below.

The alignment direction of the mesogens in the network reflects the initial alignment of the mixture. In this way, a planarly (horizontally, in the plane of the fibre) or homeotropically (vertically, perpendicular to the plane of the fibre) oriented network can be created. The initial alignment is dictated by interfacial interactions between the LC mixture and alignment layers such as the before described examples of rubbed polyimide or photoalignment layers.

FIGS. 6a and 6b show schematically an anisotropic gel initially in the off-state in FIG. 6a, and then in the on-state in FIG. 6b. The anisotropic gel comprises polymer chains 40 with mesogenic side-chains 42, and non-reactive mesogens 44.

In the off-state, when no electrical field is applied, the inert liquid crystal solvent molecules are aligned with the mesogenic units of the network. Consequently, due to the refractive index match between the mesogenic units of the network and those of the inert liquid crystal solvent molecules, incident light is not scattered, and the system will appear transparent.

However, in the presence of an electrical field, the liquid crystal solvent molecules will reorientate along the field lines. Light scattering will occur due to the induced domain formation, and the resulting refractive index mismatch, and the system will become opaque.

Fibres incorporating such electro-optically active layers do not require polarizers, as the switching principle is based on the induced scattering resulting from the refractive index mismatch in the on-state, rather than modulation of the polarization state of the incident light, and can produce fast switching fibres, as the mesogenic units in the polymer network provide the internal director field that forms the driving force for relaxation to the aligned state in the field-off condition. The fibres have good mechanical stability, and there is almost no viewing angle dependency due to the refractive index matching between the low molecular weight LC component and the mesogenic moieties of the network.

Alignment layers are, however, required when using such an electro-optically active substance, since the alignment direction of the mesogens in the network reflects the initial alignment of the mixture, which in turn is dictated by the interfacial interactions between the LC mixture and alignment layers.

The term “polymer” as used hereinabove, should be understood to include also the term “oligomer”.

1. A filament or fibre (2) comprising:
a first conductive layer (4);
an electro-optically active layer (6);
a second conductive layer (8);
wherein the filament or fibre has an off-state and an on-state, the electro-optically active layer comprising a combination of an electro-optically active substance and a polymer.

2. A filament or fibre according to claim 1 wherein the electro-optically active substance comprises a liquid crystalline material.

3. A filament or fibre according to claim 1 wherein the polymer content is substantially between 0.5 to 40%.

4. A fibre or filament according to claim 1 wherein the electro-optically active substance comprises ferro-electric phase.

5. A filament or fibre according to claim 1 wherein the polymer content is substantially between 30% to 99.8%.

6. A filament or fibre according to claim 1 wherein the polymer comprises a substantially isotropic polymer phase, and the liquid crystalline material comprises a dispersed liquid crystalline phase.

7. A filament or fibre according to claim 5 wherein the liquid crystalline phase comprises liquid crystalline domains having an average diameter of approximately 0.5-2 μm.

8. A filament or fibre according to claim 5 wherein the electro-optically active layer comprises a polymer comprising a polymer backbone (40) to which mesogenic cores (42) are attached, and a liquid crystalline solvent.

9. A filament or fibre according to claim 5 where the liquid crystalline material comprises a liquid crystalline director, which director is controlled uniaxially.

10. A filament or fibre according to claim 5 wherein the liquid crystalline material comprises a liquid crystalline director, which director is controlled biaxially.

11. A filament or fibre according to claim 9 further comprising an alignment layer for enforcing the director control.

12. A filament or fibre according to claim 5 wherein, in one of the on-state or the off-state, the refractive index of the polymer is different to that of the liquid crystalline material, for a predetermined wavelength of incident light.

13. A filament or fibre according to claim 12, wherein in the other of the on-state or the off-state, the refractive index of the polymer matches the ordinary refractive index of the liquid crystalline material.

14. A filament or fibre according to claim 1 wherein the electro-optically active layer comprises an anisotropic polymer.

15. A filament or fibre according to claim 1 wherein the electro-optically active substance comprises material possessing a smectic phase.

16. A filament or fibre according to claim 1 wherein the electro-optically active substance comprises material possessing a chiral nematic phase or cholesteric phase, optionally induced by a chiral dopant.

17. A filament or fibre according to claim 1 wherein the polymer is at least partly based on non-covalent, supramolecular interactions.

18. A fibre or filament (2) according to claim 1 having a substantially circular cross-section, the first conductive layer (4) comprising an inner conductive core extending axially along the filament or fibre, and the second conductive layer (8) comprising an outer electrode, the electro-optically active layer (6) being positioned between the inner core and the outer electrode.

19. A fibre or filament according to claim 18 wherein the outer electrode is at least partially transparent.

20. A fibre or filament according to claim 18 further comprising a first coating layer completely or partially coating the conductive core.

21. A fibre or filament according to claim 18 further comprising a second coating layer positioned between the electro-optically active layer and the outer electrode.

22. A fibre or a filament according to claim 18 where the or each coating layer comprises an alignment layer.

23. A fibre or filament according to claim 18 further comprising one or more metal wires wound around the outer electrode.

24. A fibre or filament according to claim 18 further comprising spacers positioned between the inner electrode and the outer electrode.

25. A fibre or filament according to claim 24 wherein the spacers are formed from a non-conductive material.

26. A fibre or filament according to claim 1 having a substantially square or rectangular cross-section, the first conductive layer (18) comprising a bottom electrode, the second conductive layer (16) comprising a top electrode, and the electro-optically active layer (14) being positioned between the bottom and top electrode layers.

27. A method for forming a filament or fibre (2) comprising:
forming a first conductive layer (4);
applying an electro-optically active layer (6) either directly, or indirectly, to the first conductive layer;
applying a second conductive layer (8), either directly, or indirectly, to the electro-optically active layer, wherein the electro-optically active layer is formed by:
(i) forming the electro-optically active layer from a homogeneous system of cross linkable monomers and a non-reactive mesogen, prior to applying the electro-optically active layer to the first conductor;
(ii) inducing a phase change in the homogeneous system.

28. A method according to claim 27 wherein the phase change is induced before application of the second conductive layer.

29. A method according to claim 27 wherein the step of inducing a phase change comprises heating the filament or fibre.

30. A method for forming a filament or fibre comprising:
forming a first conductive layer;
applying an electro-optically active layer either directly, or indirectly, to the first conductive layer;
applying a second conductive layer, either directly, or indirectly, to the electro-optically active layer, wherein the electro-optically active layer is formed by:
(i) forming the electro-optically active layer from a homogeneous system of at least a polymer and a non-reactive mesogen, in combination with a common solvent, prior to applying the electro-optically active layer to the first conductor;
(ii) removing of the solvent.

31. A method according to claim 30 wherein the solvent is removed before application of the second conductive layer.
